(19) United States
(12) Patent Application Publication
(10) Pub. No.: US 2008/0163347 A1
(43) Pub. Date: Jul. 3, 2008

(54) Method to maintain or remove access rights

(76) Inventors: Peggy Ann Ratcliff, Morton, IL (US); John Charles Anderson, Washington, IL (US); Victoria Lynn Logan, Peoria, IL (US); Paul Matthew McCarron, Morton, IL (US); Jana Evans Soviar, Peoria, IL (US); Michelle Lee Campbell-Castaline, Peoria, IL (US); Sondra Jean Franks, Delavan, IL (US); Randall Charles Walker, Morton, IL (US); Paulette L. Holler, Morton, IL (US); Margaret Anne Gutgesell, Metamora, IL (US); Kathleen P. King, Secor, IL (US); David Lee Brewer, Chillicothe, IL (US); Jack Anthony Nieukirk, Peoria, IL (US); Gail E. Polonus, Peoria, IL (US); David Charles White, Peoria, IL (US); Paul Richard Rybarczyk, Peoria, IL (US); Nicole Yvette Graves, Peoria, IL (US); Peggy Ann Heath, Pekin, IL (US); Russell M. Beale, Peoria, IL (US); Lowell L. Trammell, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/646,457

(22) Filed: Dec. 28, 2006

(51) Int. Cl. H04L 9/32

(52) U.S. Cl. 726/6

(57) ABSTRACT

A method is disclosed for managing access rights. The method generates a record associated with a change in a status for an individual and sends notification of the change in status to a first entity. The method also determines, by the first entity, if there is to be a change in one or more access levels associated with the individual. The method further sends notification to a second entity if the first entity determines that there is to be a change in the one or more access levels. In addition, the method changes, by the second entity, the one or more access levels.

### TECHNICAL FIELD

The present disclosure relates generally to systems and methods to manage access rights, and more particularly, to a system and method to maintain or remove access rights for controlled access points.

### BACKGROUND

Business often have many points of controlled access for their facilities, information systems, and the like. These controlled access points may include, for example, buildings, offices, machinery, equipment, computer systems, programs, databases, proprietary information, etc. In order to maintain the integrity of these controlled access points, a business may allow access only to employees requiring access and may re-evaluate these accesses periodically. For example, a business may allow access to certain controlled access points when an employee is hired, when an employee moves into a job position requiring new or different accesses, when job requirements change to require new or different accesses, etc. Similarly, a business may remove access rights to controlled access points when the status of an employee changes. For example, a business may remove access rights to certain controlled access points when an employee transfers from one business unit to another or leaves the business entirely.

Decisions to remove access rights may be based on periodic evaluations including, for example, audits, data comparisons, and the like. Based on the results of these evaluations, a business may make a decision to maintain or remove access to one or more controlled access points for one or more employees, thereby maintaining the security of the system. The ability to identify when the results of an evaluation require a change in access may provide increased compliance with regulatory or security requirements, as well as improved tracking and auditing.

Systems and methods have been created for integrating security and access for facilities and information systems. One such example is U.S. Patent Publication Number 2003/0023874 (the '874 publication) to Prokupets et al. published on Jan. 30, 2003. The '874 publication discloses an access control system for controlling entry/exit to areas of facilities (e.g., buildings, physical protection systems, etc.), as well as to access information resources and network environments. In addition, the '874 publication discloses a security server for downloading user data and updating access privileges when user data affecting security is changed. According to the '874 publication, based on data received from an external database, the security server determines the access privileges for facility protection systems, which control access to facilities, and access privileges for information systems.

Although the system and method of the '874 publication may enable the security server to determine access privileges to facilities and information systems, the system and method do not provide for ownership of controlled access points, nor does the system and method allow owners of controlled access points to make decisions whether to maintain or remove access to controlled access points. In addition, the system and method of the '874 publication do not provide segregation of responsibilities for maintaining and removing access. Thus, the system of the '874 publication does not provide mechanisms to automatically notify the owners of a change in employee status that may require evaluation and/or change of access to controlled access points, and thereby allow the data owner to selectively determine access rights which may be implemented by a separate and segregated entity.

The disclosed embodiments are directed to overcoming one or more of the problems set forth above.

### SUMMARY OF THE INVENTION

In one aspect, the present disclosure is directed to a method for managing access rights. The method generates a record associated with a change in a status for an individual and sends notification of the change in status to a first entity. The method also determines, by the first entity, if there is to be a change in one or more access rights associated with the individual based on the change in status. The method further sends notification to a second entity if the first entity determines that there is to be a change in the one or more access rights. In addition, the method changes, by the second entity, the one or more access rights.

In another aspect, the present disclosure is directed to a computer-readable medium, including instructions for performing a method, when executed by a processor, for managing access rights. The method generates a record associated with a change in a status for an individual and sends notification of the change in status to a first entity. The method also determines, by the first entity, if there is to be a change in one or more access rights associated with the individual based on the change in status. The method further sends notification to a second entity if the first entity determines that there is to be a change in the one or more access rights. In addition, the method changes, by the second entity, the one or more access rights.

In another aspect, the present disclosure is directed to a system for managing access rights. The system includes at least one memory storing data and instructions and at least one processor configured to access the memory. The at least one processor is further configured to generate a record associated with a change in a status for an individual and sends notification of the change in status to a first entity. The at least one processor is also configured to receive an indication from the first entity if there is to be a change in one or more access rights associated with the individual based on the change in status. The at least one processor further sends notification to a second entity if the first entity indicates that there is to be a change in the one or more access rights. In addition, the at least one processor is configured to receive, from the second entity, a change in the one or more access rights and change the one or more access rights.

### BRIEF DESCRIPTION OF THE DRAWINGS

FIG. 1 is a block diagram of an exemplary system consistent with certain disclosed embodiments; and

FIGS. 2a and 2b are flow charts illustrating an exemplary process for maintaining or removing access rights consistent with certain disclosed embodiments.

### DETAILED DESCRIPTION

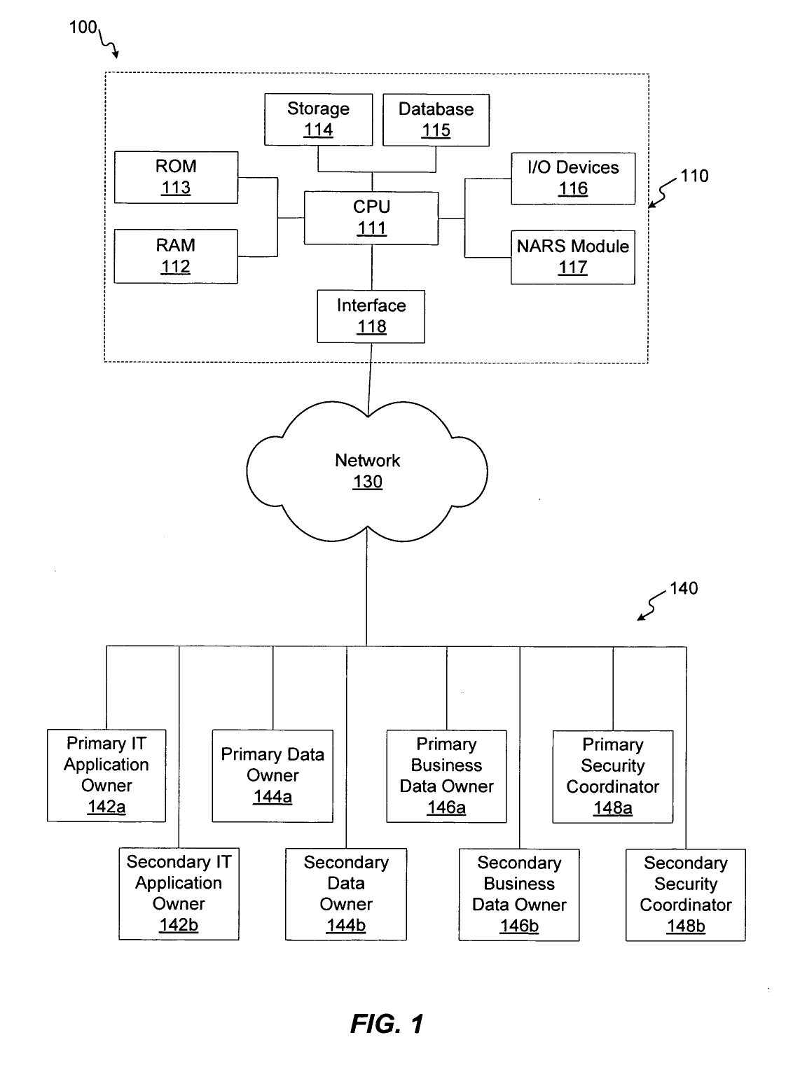

FIG. 1 illustrates an exemplary system architecture 100 for which systems and methods consistent with the disclosed embodiments may be implemented. As shown in FIG. 1, system architecture 100 may include one or more hardware and/or software components configured to display, collect, store, analyze, evaluate, distribute, report, process, record, and/or sort information associated with maintaining or removing access rights for controlled access points. System architecture 100 may include Notification for Access Removal System (NARS) computing system 110, network 130, and one or more NARS entities 140.

NARS computing system 110 may be configured to receive, collect, analyze, evaluate, report, display, and distribute data related to maintaining or removing access rights for controlled access points. For example, NARS computing system 110 may include one or more of a central processing unit (CPU) 111, a random access memory (RAM) 112, a read-only memory (ROM) 113, a storage 114, a database 115, one or more input/output (I/O) devices 116, Notification for Access Removal System (NARS) modules 117, and interface 118. NARS computing system 110 may be a server, client, mainframe, desktop, laptop, network computer, workstation, personal digital assistant (PDA), tablet PC, scanner, telephony device, pager, and the like. In one embodiment, NARS computing system 110 may be a computer configured to receive and process information associated with access rights for controlled access points. In addition, one or more constituent components of NARS computing system 110 may be co-located with any one or more business units, facilities, warehouses, sales and/or distribution centers, manufacturing sites, and the like.

CPU 111 may include one or more processors, each configured to execute instructions and process data to perform functions associated with NARS computing system 110. As illustrated in FIG. 1, CPU 111 may be communicatively coupled to RAM 112, ROM 113, storage 114, database 115, I/O devices 116, NARS modules 117, and interface 118. CPU 111 may be configured to execute computer program instructions to perform various processes and methods consistent with certain disclosed embodiments. In one exemplary embodiment, computer program instructions may be loaded into RAM 112 for execution by CPU 111.

RAM 112 and ROM 113 may each include one or more devices for storing information associated with an operation of NARS computing system 110 and/or CPU 111. For example, ROM 113 may include a memory device configured to access and store information associated with NARS computing system 110, including information for identifying, initializing, and monitoring the operation of one or more components and subsystems of NARS computing system 110. RAM 112 may include a memory device for storing data associated with one or more operations of CPU 111. For example, instructions stored on ROM 113 may be loaded into RAM 112 for execution by CPU 111.

Storage 114 may include any type of storage device configured to store any type of information used by CPU 111 to perform one or more processes consistent with the disclosed embodiments. Storage 114 may include one or more magnetic and/or optical disk devices, such as, for example, hard drives, CD-ROMs, DVD-ROMs, a universal serial bus (USB) port, a floppy, or any other type of mass media device.

Database 115 may include one or more software and/or hardware components that store, organize, sort, filter, and/or arrange data used by NARS computing system 110 and/or CPU 111. Database 115 may store one or more tables, lists, or other data structures containing data associated with maintaining or removing access rights. For example, database 115 may store information associated with controlled access points, such as, for example, type of access rights (i.e., access to a particular building, access to particular data, etc.), level of access rights (i.e., full access, partial access, restricted access, access to a particular building only during business hours or twenty-four hour access, full access to particular data including read and write privileges, limited access to particular data including only read privileges, restricted access, etc.), etc., that may be used by CPU 111 to receive, categorize, prioritize, save, send, or otherwise manage data associated with the maintaining or removing access rights. In addition, database 115 may store additional and/or different information than that listed above.

I/O devices 116 may include one or more components configured to communicate information associated with NARS computing system 110. For example, I/O devices 116 may include a console with an integrated keyboard and mouse to allow a user to input parameters associated with NARS computing system 110 and/or data associated with the employee status, access rights, access data, and automated processing to maintain or remove access rights. I/O devices 116 may include one or more displays or other peripheral devices, such as, for example, printers, cameras, microphones, speaker systems, electronic tablets, bar code readers, scanners, or any other suitable type of I/O device 116.

NARS modules 117 may include one or more software programs, instructions, and/or listings configured to perform processes consistent with certain disclosed embodiments. For example, NARS modules 117 may include a computer program product stored on computing system 110 and configured to be executed by CPU 111 to perform one or more processes for receiving and processing information associated with maintaining or removing access rights.

Interface 118 may include one or more components configured to transmit and receive data via network 130, such as, for example, one or more modulators, demodulators, multiplexers, de-multiplexers, network communication devices, wireless devices, antennas, modems, and any other type of device configured to enable data communication via any suitable communication network. Interface 118 may also be configured to provide remote connectivity between CPU I 11, RAM 112, ROM 113, storage 114, database 115, one or more input/output (I/O) devices 116, and/or NARS modules 117 to collect, analyze, and distribute data or information associated with maintaining or removing access rights.

NARS computing system 110 may include additional, fewer, and/or different components than those listed above and it is understood that the listed components are exemplary only and not intended to be limiting. For example, one or more of the hardware components listed above may be implemented using software. In one exemplary embodiment, storage 114 may include a software partition associated with one or more other hardware components of NARS computing system 110. Additional hardware or software may also be used to operate NARS computing system 110, such as, for example, security applications, authentication systems, dedicated communication systems, etc. The hardware and/or software may be interconnected and accessed as required by authorized users. In addition, a portion, or all of, NARS computing system 110 may be hosted and/or operated offsite using, for example, commercial servers, commercial application providers, and the like.

Network 130 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with network 130 may be wired, wireless, or any combination thereof. In one exemplary embodiment, network 130 may allow communication between NARS computing system 110 and one or more controlled access points (not shown). Thus, network 130 may allow NARS computing system 110 to communicate access rights files and/or access rights data to one or more controlled access points.

Controlled access points may include any point at which one or more mechanisms may be utilized to establish controls and/or restrictions. Mechanisms that may be used to establish controls and/or restrictions may include any type of physical and/or electronic means, many of which are well-known in the art. Controlled access points may be utilized in any environment, including mechanical, electrical, informational, and the like. For example, controlled access points may be used with facilities, buildings, offices, elevators, doors, gates, machines, machinery, heavy equipment, tools, office equipment, vehicles, watercraft (i.e., boats, ships, etc.), aircraft, computer systems, networks, computers, telephony or other communication equipment and devices, etc. Other, non-limiting examples of the use of controlled access points may include, for example, systems and/or applications for invoices and invoice processing, systems and/or applications for purchase orders and purchase order processing, systems and/or applications for payroll and payroll processing, human resources systems and/or applications, financial services systems and/or applications, security systems and/or applications, networks, programs, databases, data tables, data structures, proprietary information, etc. As an example, a building may have several doors, each of which may serve as a controlled access point, and the mechanisms to control each of these controlled access points may consist of one or more electromechanical locks. As another example, a database may have a single controlled access point, e.g., the software application used to access the database. Alternatively, the database may have a number of controlled access points, e.g., the software application, network security applications, and a database application. The mechanism to control access to the database may consist of a further software application, which may be configured to manage access to the database. Controlled access points may require the use of keys, codes, biometric, or other devices by which the controlled access point may restrict or control access.

Controlled access points may be represented by one or more access rights files. That is, for each controlled access point there may be one or more associated access rights files. In addition, for each access rights file, there may be one or more associated access rights. The access rights may include any type and/or level of access available for the associated controlled access point. Access rights may include, for example, not allowing access, allowing certain types of physical access rights (i.e., access at any time, access during certain hours, accompanied access, etc.), allowing certain types of data access rights (i.e., read, write, approval and/or authorization rights, oversight rights, etc.), allowing access with restrictions (i.e., probationary, secondary approval requirement, oversight requirement, etc.), allowing full and/or unrestricted access rights, and the like. Access rights to finance-related mechanisms may further include, for example, primary or secondary approval rights (e.g., approvals to a certain dollar amount, secondary approval requirements, purchase order approval, check disbursement approval, invoice approval, etc.), authorization rights (e.g., authorization to ship, authorization to receive, etc.), auditing rights, etc.

In addition, access rights may be assigned based on a predetermined segregation of duties. That is, it may be desirable, necessary, and/or advantageous that a specific controlled access point have certain duties and/or responsibilities (i.e., access rights) assigned to different employees. For example, for the “invoices” controlled access point, it may not be desirable that the same employee have access rights to create, modify, and approve an invoice. Thus, the different access rights associated with invoices may be granted to different employees, and this will be reflected in the “invoices” access rights file. Segregation of duties may also be used, for example, in purchase orders, sales order, credit memos, supplier data, human resources and payroll data, ledger changes or adjustments, or any other type of application in which it may be desirable or beneficial to segregate responsibilities and/or authority. The segregation of duties may be determined based on security and/or regulatory requirements and concerns.

The access rights file may include identification of the controlled access point (e.g., name, pseudonym, physical or electronic location of the controlled access point, etc.), a list of employees having access to that controlled access point, and one or more types of access rights granted to each employee included in the list. For example, the access rights file for Building A may include the name of every employee granted access to Building A and, associated with each employee, may be one or more types of access granted to that individual. In this example, if Building A were a manufacturing facility having three shifts and two production lines, access rights held by each individual employee may be limited to a period of time surrounding their assigned shift (e.g., their shift plus one hour before their shift starts and one hour after their shift ends) and the section of Building A in which their assigned production line operates. As another example, the access rights file for Purchase Orders (POs) may include the name of every employee having access rights to POs. In this example, a first set of employees may have access rights to write POs, a second set of employees may have access rights to approve POs up to a certain dollar amount, and a third set of employees may have access rights to provide secondary approval or approval of POs exceeding a certain dollar amount.

NARS entities 140 may be connected to NARS computing system 110 through network 130. NARS entities 140 may be any individual or group associated with owning, granting, updating, viewing, or otherwise maintaining or removing access rights. In addition, NARS entities 140 may include one or more individuals or groups responsible for oversight of access rights. In one exemplary embodiment, NARS entities 140 may include primary IT application owner 142a, secondary IT application owner 142b, primary data owner 144a, secondary data owner 144b, primary business data owner 146a, secondary business data owner 146b, primary security coordinator 148a, and security coordinator 148b. In addition, NARS entities 140 may be subject to segregation of duties such that the responsibilities and rights associated with primary IT application owner 142a, secondary IT application owner 142b, primary data owner 144a, secondary data owner 144b, primary business data owner 146a, secondary business data owner 146b, primary security coordinator 148a, and security coordinator 148b are assigned to different employees. Further, access rights associated with primary IT application owner 142a, secondary IT application owner 142b, primary data owner 144a, secondary data owner 144b, primary business data owner 146a, secondary business data owner 146b, primary security coordinator 148a, and security coordinator 148b may be specified in one or more access rights files. In other words, each access rights file may specify one or more employees having access rights associated with primary and secondary IT application owners 142, one or more employees having access rights associated with primary and secondary data owners 144, one or more employees having access rights associated with primary and secondary business data owners 146, and one or more employees having access rights associated with primary and secondary security coordinators 148.

IT application owner 142 may be any individual or group responsible for the creation and/or maintenance of access rights files in NARS computing system 110. In addition, IT application owner 142 may be responsible for providing technical support to other NARS entities 140. IT application owner 142 may include primary IT application owner 142a and secondary IT application owner 142b. In one embodiment, IT application owner 142 may view and/or edit access rights items associated with access rights files for which IT application owner 142 is responsible. Access rights items may include, for example, access rights files, access rights reports, access rights histories, lists of employees having access rights, and the like.

Data owner 144 may be any individual or group responsible for determination of access rights. Data owner 144 may be responsible for responding to inquiries regarding status of access rights, making determinations regarding access rights removal and maintenance, providing comments or substantiation for determinations, providing effective dates for any changes or modifications, etc. Data owner 144 may include primary data owner 144a and secondary data owner 144b. In one embodiment, data owner 144 may only view and/or edit activities associated with maintaining or removing access rights for controlled access points for which they are responsible. Data owner 144 may be responsible to business data owner 146 for any actions or determinations associated with an access data file for which business data owner 146 is responsible.

Business data owner 146 may be any individual or group responsible for access rights to controlled access points for a business unit. Business data owner 146 may be responsible for responding to notifications of inaction by data owner 144 and/or security coordinator 148, performing regular review or auditing of access rights, ensuring compliance with regulatory requirements (i.e., Sarbanes-Oxley, etc.), oversight of access rights, and the like. Business data owner 146 may include primary business data owner 146a and secondary business data owner 146b. Business data owner 146 may be responsible for oversight of one or more controlled access points and their corresponding access rights files. In addition, business data owner 146 may be responsible for oversight of one or more data owners 144 and security coordinators 148. In one embodiment, business data owner 146 may view all activity associated with maintaining or removing access rights, but may not edit data or perform any actions.

Security coordinator 148 may be any individual or group responsible for controlling access rights maintenance, responding to inquiries and/or notifications from NARS computing system 110, completing access rights actions as indicated by data owner 144, recording actions into NARS computing system 110, etc. Security coordinator 148 may include primary security coordinator 148a and secondary security coordinator 148b. In one embodiment, security coordinator 148 may only view and/or edit access rights activity that require action by security coordinator 148.

NARS entities 140 may each include one or more computing devices (i.e., desktop, laptop, mainframe, server, client, handheld computing device, personal digital assistant, telephony device, tablet PC, bar code reader, scanner, etc.) and various other hardware and/or software components (not shown). The one or more computing devices may allow NARS entities 140 to connect to and communicate with NARS computing system 110 by means of network 130.

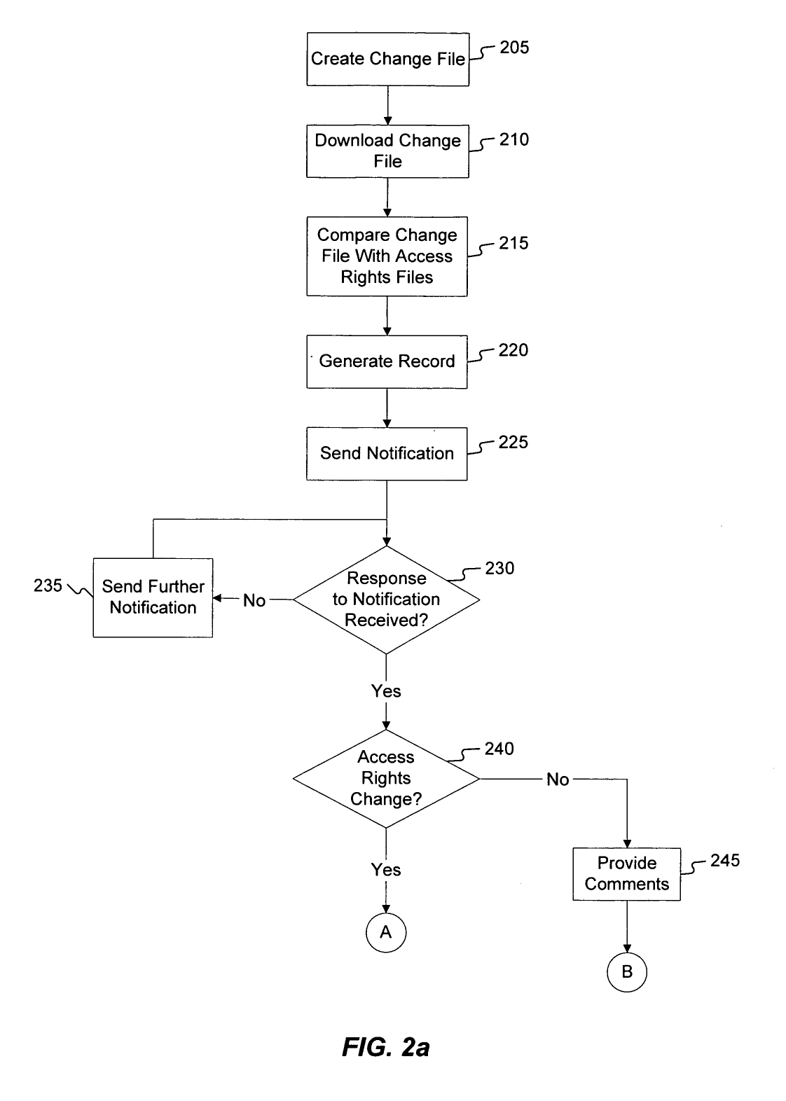

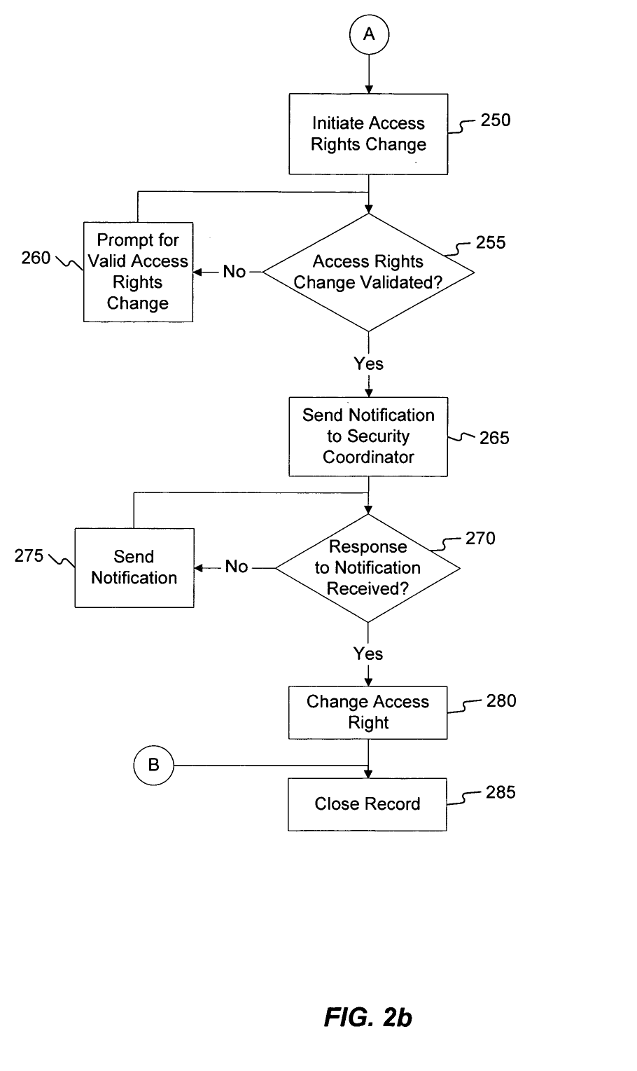

FIGS. 2a and 2b illustrate a flowchart of an exemplary process for maintaining or removing access consistent with certain disclosed embodiments. The process of FIGS. 2a and 2b may be performed by NARS computing system 110. For example, NARS computing system 110 may execute one or more software programs that may perform one or more of the process steps of FIGS. 2a and 2b.

Referring to FIG. 2a, when the status of an employee changes, a change file may be generated (step 205). The change file may be generated automatically or may be created upon receipt of a manual command. In one exemplary embodiment, the change file may be generated from a human resources computing system. The change file may include the name and/or other identifying information for every employee who has separated from the business (e.g., quit, fired, retired, laid off, etc.), changed positions (e.g., promotion, transfer, etc.), or otherwise had a change in responsibilities during a predetermined period of time (e.g., weekly, daily, hourly, immediately upon notification of change in employee status, etc.). In some embodiments, the frequency of the change file generation may be determined based on security and/or regulatory concerns such that businesses or applications requiring a high level of security generate a change file immediately upon notification of a change in employee status.

Once the change file is generated, NARS computing system 110 may download and/or store the change file (step 210). NARS computing system 110 may download and store the change file on a regular predetermined basis. As with generation of the change file, the frequency with which the change file is downloaded may be determined based on security and/or regulatory concerns such that businesses or applications requiring a high level of security download change files immediately upon creation of the change file. In one exemplary embodiment, NARS computing system 110 may download the change file from a human resources computing system.

NARS computing system 110 may compare the change file with one or more access rights files stored in database 115 (step 215). In particular, NARS computing system 110 may parse the change file and one or more access rights files, compare the names, employee identification number, and/or other identifying information with one or more access files, and determine the current access rights associated with each employee listed in the change file. In one exemplary embodiment, the one or more access rights files may include every access rights file stored in database 115. Alternatively, NARS computing system 110 may compare the change file with select or predetermined access rights files stored in database 115. In addition, NARS computing system 110 may interface with other computing systems (not shown) to compare the change file with access rights files stored therein.

When NARS computing system 110 determines that an employee listed in the change file is listed in one or more access rights files, NARS computing system 110 may generate a record (step 220). In one embodiment, the record may be generated automatically. Alternatively and/or additionally, the record may be created manually by, for example, data owner 142, business data owner 144, security coordinator 146, and the like.

The record may include the name and/or other identifying information of the employee found in both the change file and the access rights file, as well as the name of the access rights file. In addition, the record may include the level of access rights granted to the employee and information associated with the access rights file, including primary and secondary IT application owner 142, primary and secondary data owner 144, primary and secondary business data owner 146, and primary and secondary security coordinator 148. A single record may be generated for each employee, each access rights file, each IT application owner 142, each data owner 144, each business data owner 146, each security coordinator 148, and the like. Alternatively and/or additionally, a single record may be created for multiple employees, multiple access rights files, multiple IT applications owners 142, multiple data owners 144, multiple business data owners 146, multiple security coordinators 148, and the like. In one exemplary embodiment, a single record may be generated for each access rights file in which an employee is found to have access rights.

In addition, a record may also be generated when a segregation of duties conflict is identified. That is, if one employee is identified as having two or more access rights levels that are in conflict with one another, NARS computing system 110 may generate a record. For example, if one employee has access rights to create an invoice and access rights to approve an invoice, a segregation of duties conflict may be identified and a record generated. As another example, if one employee has access rights as data owner 144 and access rights as business data owner 146, a segregation of duties conflict may also be identified and a record generated. The conflict may be determined during an auditing activity, when a segregation of duties is created, when a new access right is created, and the like. For example, if it is determined that a new segregation of duties is required, an associated segregation of duty file defining the segregation of duties may be created. The segregation of duty file may be compared with current access rights files and current access rights levels to determine if there is a segregation of duties conflict. If a segregation of duties conflict is discovered in this process, a record may be generated. For example, if it was initially allowed for the same employee to maintain access rights to create an invoice and access rights to approve an invoice, but was later changed to segregate the creation and approval access rights, a segregation of duties file and/or data structure may be created reflecting that segregation of duties.

Once a record is generated, notification may be sent to the data owner 144 associated with the access rights file identified in the record (step 225). The notification may be sent electronically, such as, for example, by e-mail, alert, page, automated telephone call, and/or any other type of electronic notification. In addition, the notification may be sent to the primary data owner 144a, the secondary data owner 144b, or both. In one exemplary embodiment, the notification may be sent to both the primary and secondary data owner 144, and may include name of the access rights file, name and/or other identifying information associated with the employee, current access rights level, etc. Alternatively, the notification may be sent to primary data owner 144a and, if the notification is not responded to within the predetermined period of time, a further notification may be sent to secondary data owner 144b. In addition, the notification may include information associated with IT application owner 142, data owner 144, business data owner 146, security coordinator 148, and the like.

Data owner 144 may respond to the notification (step 230) within a predetermined period of time, such as, for example, a certain number of hours, days, weeks, or the like. The response may include, for example, viewing the record, editing the record, closing the record, and the like. Response to the notification may be required or may be optional. In one exemplary embodiment, response may be required in order to comply with regulatory and/or security requirements or rules. In addition, the predetermined period of time may also be determined based on regulatory and/or security requirements or rules.

If data owner 144 does not respond to the notification within the predetermined period of time (step 230, No), a further notification may be sent (step 235). In one embodiment, the further notification may be sent to primary business data owner 146a, secondary business data owner 146b, or both. As with the notification sent to data owner 144, business data owner 146 may be expected to respond within a predetermined period of time. If a response is not received from business data owner 146, a further notification may be sent to business data owner 146. Alternatively and/or additionally, if an unacknowledged notification was previously sent only to primary data owner 144a, the further notification may be sent to secondary data owner 144b. As with the notification sent to primary data owner 144a, secondary data owner 144b may be expected to acknowledge and/or respond within a predetermined period of time. If acknowledgement and/or response is not received from either primary data owner 144a or secondary data owner 144b, then further notification may be sent to business data owner 146.

As with the notification to data owner 144, notification to business data owner 146 may be sent electronically, such as, for example, by e-mail, alert, page, automated telephone call, and/or any other type of electronic notification. In addition, the notification may be sent to the primary business data owner 146a, the secondary business data owner 146b, or both. In one exemplary embodiment, the notification may be sent to both the primary and secondary business data owner 146. Alternatively, the notification may be sent to primary business data owner 146a and, if a response to the notification is not received, as discussed in greater detail below, a further notification may be sent to secondary business data owner 146b. The notification may include the name of the access rights file, the name and/or other identifying information associated with the employee, current access rights level, etc. In addition, the notification may include information associated with IT application owner 142, data owner 144, business data owner 146, security coordinator 148, and the like.

The business data owner 146 may be expected to respond to the notification (step 230) within a predetermined period of time. The predetermined period of time may be hours, days, weeks, or the like. If the business owner 146 does not respond (step 230, No) before the predetermined period of time expires, then notification may again be sent to business data owner 146 (step 235). In one embodiment, the business data owner 146 may acknowledge the notification by requesting data owner 144 to access and/or edit the record. As discussed above, the response by data owner 144 may include, for example, viewing the record, editing the record, closing the record, and the like. Response to the notification may be required or may be optional. In one exemplary embodiment, response may be required in order to comply with regulatory and/or security requirements or concerns.

When data owner 144 responds to the notification, data owner 144 may determine if an access rights change is to be made (step 240). A change in access rights may include, for example, changing an access rights level, removing access rights, and the like. In one exemplary embodiment, data owner 144 may make the determination based on data found in the record.

If data owner 144 determines that there is to be no change to the access rights for the employee (step 240, No), data owner 144 may provide comments or other indication of reasons for the determination (step 245). Comments may be provided through edit boxes, check boxes, drop-down and pull-down menus, radio buttons, and the like presented on a graphical user interface (GUI). In addition, NARS computing system 110 may verify the comments provided. For example, NARS computing system 110 may verify that one or more selections are made if radio buttons, pull-down and drop-down menus are provided. In addition, NARS computing system 110 may verify combinations of selections. For example, if a predetermined radio button is selected, NARS computing system 110 may require that text be entered into an edit box. Whereas, if a different predetermined radio button is selected, NARS computing system 110 may not require text to be entered into an edit box. Alternatively and/or additionally, if an edit box is provided for comments, NARS computing system 110 may be configured to validate the text inserted. In some embodiments, NARS computing system 110 may be configured to validate the text only in select situations, such as, for example, predetermined controlled access points, predetermined access rights levels, and the like. Alternatively and/or additionally, NARS computing system 110 may validate text or require certain selections/entries based on the reasons for record creation. For example, if an employee is separated from the business, NARS computing system 110 may require a minimum amount of text to support a determination that access by that employee to a controlled access point is not to be changed.

If data owner 144 determines that there is to be a change to the access rights for the employee (step 240, Yes), data owner 144 may initiate an access rights change on NARS computing system 110 (step 250). In one exemplary embodiment, data owner 144 may initiate the change within the record. Alternatively, NARS computing system 110 may provide mechanisms for data owner 144 to initiate a change in access rights, such as, for example, dialog boxes, check boxes, radio buttons, pull-down and drop-down menus, and the like. In addition, data owner 144 may select or input a new or changed access right to NARS computing system 110. For example, data owner 144 may access the record and within the record may select the new access rights level.

Once new or changed access rights information has been selected, NARS computing system 110 may validate the access rights change (step 255). Validation may include, for example, verifying qualifications of the employee for the selected access level (e.g., if a security clearance is required for a particular access right, then verifying that the employee possesses that security clearance, if a license is required for performance of a particular function, then verifying that the employee possesses the license, etc.), verifying that a segregation of duties conflict is not introduced by the selection (e.g., that the employee does not already possess an access right that is in conflict with the change initiated by data owner 144 in step 250, etc.), verifying that the desired number, kind, and type of access rights are met (e.g., that at least one employee retains primary and one retains secondary access rights, at least one employee remaining with the designated access right, etc.), and the like.

If validation fails (step 255, No), data owner 144 may be prompted to enter a valid access rights change (step 260). In addition, NARS computing system 110 may provide an indication to data owner 144 of reasons for validation failure. The indication may be provided by means of a dialog box, text box, or other mechanism by which NARS computing system 110 may communicate information to data owner 144. In one exemplary embodiment, notification is provided through a graphical user interface.

If validation is successful (step 255, Yes), NARS computing system 110 may send notification to security coordinator 148 (step 265). As with the notifications sent to data owner 144 and business data owner 146, notification to security coordinator 148 may be sent electronically, such as, for example, by e-mail, alert, page, automated telephone call, and/or any other type of electronic notification. In addition, the notification may be sent to primary security coordinator 148a, secondary security coordinator 148b, or both. In one exemplary embodiment, the notification may be sent to both the primary and secondary security coordinator 148, and may include the name of the access rights file, the name and/or other identifying information associated with the employee, current access rights level, the requested change in access rights, etc. In addition, the notification may include information associated with IT application owner 142, data owner 144, business data owner 146, security coordinator 148, and the like.

Security coordinator 148 may change the access rights for the employee according to the determination by data owner 144 (step 280). The change in access rights may be reflected in the access rights file stored in NARS computing system 110. The change in access rights may be made directly to the access rights file or may be made indirectly to the access rights file through an interface operating on and/or interfacing with NARS computing system 110. The change may include, for example, changing the access rights for an employee included in the access rights file, removing the employee's information from the access rights file, maintaining the employee's information in the access rights file but removing an associated access right, and the like.

Once the security coordinator has completed the change in access rights, NARS computing system 110 may close the record (step 285). The record may be closed automatically once NARS computing system 110 determines that the change has been made, e.g., the original access right is now changed. Alternatively and/or additionally, security coordinator 148 may provide an indication to NARS computing system 110 that the change has been made. In some embodiments, NARS computing system 110 may be configured to automatically verify that the changes have been made to the access rights file and that the changes made by security coordinator 148 are consistent with the determination made by data owner 144. For example, NARS computing system 110 may determine that a change has been made, the type of change, and the employee for whom the change was made, and may compare the changes with the determination made by data owner 144 in the record.

NARS computing system may store information associated with actions performed in association with the disclosed method. For example, NARS computing system 110 may record each time a record is accessed, viewed, edited, saved, etc., the identity and access rights of the entity accessing, viewing, editing, saving, etc., and any changes made. In addition, NARS computing system 110 may store information associated with accessing, viewing, editing, saving, etc. of access rights files and the like. The stored information may be viewable within an associated record or access rights file, or the stored information may be stored as a separate file. In either case, the information may be available for later review. In one exemplary embodiment, the information may be available for auditing purposes. Alternatively and/or additionally, the information may be available for security and/or regulatory purposes.

It is anticipated that there may be fewer or greater number of steps. For example, if a first notification is sent to primary data owner 144a, a second notification may be sent to secondary data owner 144b, a third notification sent to primary business data owner 146a, a fourth notification sent to secondary business data owner 146g, and all subsequent notifications sent to both primary and secondary data owners 144 as well as both primary and secondary business data owners 146.

As another example, if an overall predetermined response time is exceeded, e.g., no response is received within a predetermined period of time after notification has been sent to primary data owner 144a, secondary data owner 144b, primary business data owner 146a, and/or secondary business data owner 146b, NARS computing system 110 may automatically initiate an access rights change. The predetermined period of time may be hours, days, weeks, or the like, and may be measured from the time of first notification, the time of final notification, the time of record creation, or the like. In one exemplary embodiment, the predetermined period of time may be fourteen days and may be measured from the time of record creation.

Similarly, if an overall predetermined response time is exceeded for action by security coordinator 148, e.g., no response is received within a predetermined period of time after notification has been sent to primary security coordinator 148a, security coordinator 148b, primary business data owner 146a, and/or secondary business data owner 146b, NARS computing system 110 may automatically change access rights. The predetermined period of time may be hours, days, weeks, or the like, and may be measured from the time of first notification to data owner 144, first notification to business data owner 146, first notification to security coordinator 148, final notification to data owner 144, final notification to business data owner 146, final notification to security coordinator 148, the time of record creation, or the like. In one exemplary embodiment, the predetermined period of time may be three days and may be measured from the time of first notification to security coordinator 148.

In addition, NARS computing system 110 may be configured to automatically perform actions based on the content of the record. For example, if the record indicates that an employee has been separated, NARS computing system 110 may automatically initiate an access rights change, and may input text to the record indicating that the access rights change is automatic initiated due to separation.

As an example according to certain disclosed embodiments, at the end of each business day, a human resources computing system (not shown) may create a change file. The change file may indicate that employees John Doe, employee number 1234, and Jane Smith, employee number 5678, have changes in employment status. In this example, the change file may indicate that John Doe has separated from the business and Jane Smith has changed positions. NARS computing system 110 may download the change file, parse the change file to determine employee numbers, and compare the employee numbers with employee numbers included in access rights files stored in database 115. Based on this comparison, NARS computing system 110 may determine that John Doe has access rights to Building X (e.g., unlimited rights to access the building), a financial services computing network (e.g., full rights to access the network), and invoices (e.g., unlimited rights to view invoice data and approval rights for invoices). NARS computing system 110 may determine that Jane Smith has access rights to Building Y (e.g., daytime access rights only to the building), a financial services computing network (e.g., full rights to access the network), and invoices (e.g., limited rights to view invoice data and rights to receive merchandise associated with invoices).

NARS computing system 110 may generate a record associated with each access rights file for each employee. In this example NARS computing system may generate six records: A1 (e.g., John Doe's access rights associated with the Building X access rights file), A2 (e.g., John Doe's access rights associated with the financial service computing network access rights file), A3 (e.g., John Doe's access rights associated with the invoice access rights file), B1 (e.g., Jane Smith's access rights associated with the Building Y access rights file), B2 (e.g., Jane Smith's access rights associated with the financial services computing network access rights file), and B3 (e.g., Jane Smith's access rights associated with the invoice access rights file).

Once NARS computing system 110 has created the records, NARS computing system 110 may send a notification to the primary data owner 1 44a associated with the access rights file listed in each record. In this example, NARS computing system 110 may send one e-mail notification to the primary data owner 144a of the Building X access rights file (i.e., notification for record A1), one e-mail notification to the primary data owner 1 44a of the Building Y access rights file (i.e., notification for record B1), two e-mail notifications to the primary data owner 144a of the financial services computing network access rights file (i.e., one e-mail notification for record A2 and one e-mail notification for record B2), and two e-mail notifications to the primary data owner 144a of the invoice access rights file (i.e., one e-mail notification for record A3 and one e-mail notification for record B3). The predetermined response time in this example may be twenty-four hours during which either primary data owner 144a or secondary data owner 144b may be expected to open and edit the record.

Primary data owners 144a of the Building X access rights file and the Building Y access rights file may respond promptly to the notifications. Primary data owner 144a of the Building X access rights file may determine that access rights for John Doe should be removed completely. That is, John Doe should have no access to Building X. Primary data owner 144a of the Building X access rights file may indicate this change by selecting an appropriate option within record A1. Primary data owner 144a of the Building Y access rights file may determine that access rights for Jane Smith should be increased. That is, Jane Smith should have unlimited access to Building Y due to the requirements of her new position. Thus, primary data owner 144a of the Building Y access rights file may indicate this change by selecting an appropriate option within record B2. In addition, both primary data owners 144a may be required to input text into a text box with information substantiating their determinations. NARS computing system 110 may validate the determinations and/or textual input. If validation is successful, NARS computing system 110 may send notification to primary and/or secondary security coordinators 148 associated with the Building X access rights file and the Building Y access rights file.

Primary data owner 144a of the financial services network access rights file may be on vacation but secondary data owner 144b may receive the notifications (e.g., through e-mail forwarding, vacation or away settings in NARS computing system 110, etc.), and may respond promptly to the notifications. Secondary data owner 144b of the financial services network access rights file may determine that John Doe's access rights to the financial services network should be eliminated and Jane Smith's access rights to the financial services network should remain unchanged. Thus, secondary data owner 144b may indicate these determinations in records A2 and B2, respectively. In addition, secondary data owner 144b may be required to input text into a text box with information substantiating the determination. NARS computing system 110 may validate the determinations and/or textual input. If validation is successful, NARS computing system 110 may send notifications (i.e., one notification for each record) to primary and/or secondary security coordinators 148 associated with the Building X access rights file and the Building Y access rights file.

Primary data owner 144a of the invoice access rights file may also respond promptly to the notifications, and may determine that John Doe's access rights to the financial services network should be eliminated. Thus, primary data owner 144a may indicate this determination in record A3. However, primary data owner 144a of the invoice access rights file may determine that Jane Smith's access rights should be changed to reflect her new responsibilities. In this example, Jane Smith's current access right to invoices includes receiving merchandise associated with invoices, but her new responsibilities may require Jane Smith to approve invoices. Thus, primary data owner 144a may indicate these determinations in record B3. In addition, primary data owner 144a may be required to input text into a text box with information substantiating the determinations. NARS computing system 110 may validate the determinations and/or textual input. In this example, a segregation of duties conflict may arise if it has been determined that the approval access right is in conflict with the receiving access right. Thus, if primary data owner 144a fails to indicate removal of the receiving access right for Jane Smith yet adds the approval access right, validation may fail and primary data owner 144a may be prompted to resolve this conflict. If validation is successful, NARS computing system 110 may send notifications (i.e., one notification for each record) to primary and/or secondary security coordinators 148 associated with the invoice access rights file.

As with the notification sent to the data owner 144, NARS computing system 110 may then send one e-mail notification to primary security coordinator 148a of the Building X access rights file (i.e., for record Al), one e-mail notification to the primary security coordinator 148a of the Building Y access rights file (i.e., for record A2), two e-mail notifications to the primary security coordinator 148a of the financial services computing network access rights file (i.e., one e-mail notification for record A2 and one e-mail notification for record B2), and two e-mail notifications to the primary security coordinator 148a of the invoice access rights file (i.e., one e-mail notification for record A3 and one e-mail notification for record B3). As with the primary data owner 144a, NARS computing system may expect a response (i.e., changes to the access rights files) from either primary security coordinator 148a or secondary security coordinator 148b within a predetermined period of time, e.g., twenty-four hours. If either primary or secondary security coordinators 148 respond within that twenty-four hours, NARS computing system may close the associated records.

As another example according to certain disclosed embodiments, using records A1, A2, A3, B1, B2, and B3 as discussed above, if NARS computing system 110 does not receive a response within twenty-four hours from any one or more primary data owners 144a, NARS computing system 110 may send a further notification to secondary data owners 144b. For example, if primary data owner 144a of the Building X access rights file does not respond within twenty-four hours, NARS computing system may send an e-mail notification to secondary data owner 144b of the Building X access rights file. As with the first notification, NARS computing system 110 may have a predetermined response period, e.g., twenty-four hours, during which either primary data owner 144a or secondary data owner 144b may be expected to open and edit the record. If neither primary data owner 144a nor secondary data owner 144b of Building X access rights file responds, NARS computing system 110 may send notification to primary business data owner 146a of the Building X access rights file. Again, NARS computing system 110 may be configured to generate a further notification if a response is not received by primary data owner 144a or secondary data owner 144b within that period of time. This further notification may be sent to secondary business data owner 146b of the Building X access rights file.

Similarly, if primary security coordinator 148a does not respond within the predetermined period of time, a further notification may be sent to secondary security coordinator 148b. If neither primary security coordinator 148a nor secondary security coordinator 148b respond within that further predetermined period of time, notification may be sent to primary business data owner 146a, and then to secondary business data owner 146b if no response is received. In this way, NARS computing system 110 may be configured to escalate and ensure the record is acted upon in a timely manner.

### INDUSTRIAL APPLICABILITY

The disclosed embodiments may be implemented with processes involving supply chain management. The disclosed embodiments may achieve improved performance of maintaining or removing access rights. In particular, the disclosed embodiments may provide improved data input, tracking, and auditing of access rights, access rights files, and controlled access points.

In addition, the disclosed embodiments may be used maintaining or removing access rights to any type of individual and/or group. For example, the disclosed embodiments may be used in a rental environment where one or more renters may desire access for a period of time to a piece of equipment or building. Once the rental term expires, the disclosed embodiments can be used to maintain or remove access rights to the rented piece of equipment. In addition, the disclosed embodiments may be used in a lease environment where the lessee of an office suite may be granted access to specific areas of the building (e.g., the leased office suite, restrooms, elevators, front doors, etc.). Once the leased term expires, the disclosed embodiments may be used to maintain or remove access rights associated with the lease. As another example, the disclosed embodiments may be used in a business partnership environment where one or more business partners may be granted access to a company's networks, buildings, and data for the duration of the business relationship. Once the business relationship is severed, the disclosed embodiments may be used to maintain or remove access rights associated with the business partners and their employees. In addition, while the term employee is used throughout the disclosure, the term is meant to embody any relationship in which there may be a change in status, such as, for example, full-time employees, part-time employees, interns (paid and unpaid), agency or contract personnel, employees and/or agents of joint venture companies or similar business partners, suppliers, vendors, dealers, contractors, sub-contractors, building owners and their employees or agents, maintenance personnel, fire and rescue personnel, regulatory and/or administrative agency personnel, guest, etc. A change in status may include, for example, severing the relationship, changing the nature or scope of the relationship, and the like.

It will be apparent to those skilled in the art that various modifications and variations can be made in the system and method for maintaining or removing access rights. It is intended that the specification and examples be considered as exemplary only, with a true scope of the disclosed embodiments being indicated by the following claims and their equivalents.

What is claimed is:

1. A method for managing access rights, comprising:
generating a record associated with a change in status for an individual;
sending notification of the change in status to a first entity;
determining, by the first entity, if there is to be a change in one or more access rights associated with the individual based on the change in status;
sending notification to a second entity if the first entity determines that there is to be a change in the one or more access rights; and
changing, by the second entity, the one or more access rights.

2. The method as in claim 1, the method further including:
validating the change; and
if validation fails, sending notification of the failure to the first entity.

3. The method as in claim 2, wherein the validating the change further includes:
determining if the change in access right is in conflict with an existing access right;
rejecting the change if it is determined to be in conflict with an existing access right; and
accepting the change if it is determined not to be in conflict with an existing access right.

4. The method as in claim 1, the method further including:
providing input to the record if the first entity determines that there is to be no change in one or more access rights for the individual.

5. The method as in claim 1, wherein the record includes data associated with one or more access rights currently associated with the individual.

6. The method as in claim 1, wherein the record includes access rights data associated with at least one of the individual, the first entity, or the second entity.

7. The method as in claim 1, wherein the first entity and the second entity are different individuals within the same organization.

8. The method as in claim 1, wherein the first entity and the second entity are organizational structures within the same organization.

9. A computer-readable medium including instructions for performing a method, when executed by a processor, for managing access rights, the method comprising:
generating a record associated with a change in status for an individual;
sending notification of the change in status to a first entity;
determining, by the first entity, if there is to be a change in one or more access rights associated with the individual based on the change in status;
sending notification to a second entity if the first entity determines that there is to be a change in the one or more access rights; and
changing, by the second entity, the one or more access rights.

10. A computer-readable medium as in claim 9, the method further including:
validating the change; and
if validation fails, sending notification of the failure to the first entity.

11. A computer-readable medium as in claim 10, wherein validating the change further includes:
determining if the change in access right is in conflict with an existing access right;
rejecting the change if it is determined to be in conflict with an existing access right; and
accepting the change if it is determined not to be in conflict with an existing access right.

12. A computer-readable medium as in claim 9, wherein the method further includes:
providing input associated with the indication if the first entity provides an indication of no change in one or more access levels for the individual.

13. A computer-readable medium as in claim 9, wherein the record includes data associated with one or more access rights currently associated with the individual.

14. The computer-readable medium as in claim 9, wherein the record includes access rights data associated with at least one of the individual, the first entity, or the second entity.

15. The computer-readable medium as in claim 9, wherein the first entity and the second entity are different individuals in the same organization.

16. The computer-readable medium as in claim 9, wherein the first entity and the second entity are organizational structures in the same organization.

17. A system for managing access rights, comprising:
at least one memory storing data and instructions; and
at least one processor configured to access the memory and configured to, when executing the instructions:
generate a record associated with a change in status for an individual;
send notification of the change in status to a first entity;
receive, from the first entity, an indication of a change in one or more access rights associated with the individual, wherein the indication is based on the change in status;
send notification to a second entity if the first entity indicates that there is to be a change in the one or more access rights;
receive, from the second entity, a change in the one or more access rights; and
change the one or more access rights.

18. The system as in claim 17, wherein the at least one processor is further configured to:
validate the change; and
if validation fails, send notification of the failure to the first entity.

19. The system as in claim 18, wherein the at least one processor is further configured to:
determine if the change in access right is in conflict with an existing access right;
reject the change if it is determined to be in conflict with an existing access right; and
accept the change if it is determined not to be in conflict with an existing access right.

20. The system as in claim 17, wherein the record includes access rights data associated with at least one of the individual, the first entity, or the second entity.
